(19) United States
(12) Patent Application Publication
(10) Pub. No.: US 2017/0266722 A1
(43) Pub. Date: Sep. 21, 2017

(54) LIGHT ALLOY WHEEL, METHOD FOR MANUFACTURING SAME, AND DEVICE FOR MANUFACTURING SAME

(71) Applicant: Hitachi Metals, Ltd., Tokyo (JP)

(72) Inventors: Takeshi HARIMOTO, Kumagaya-city, Saitama Prefecture (JP); Tatsuya KOHNO, Kumagaya-city, Saitama Prefecture (JP); Shigekazu YAMADA, Kumagaya-city, Saitama Prefecture (JP)

(73) Assignee: Hitachi Metals, Ltd., Tokyo (JP)

(21) Appl. No.: 15/504,199

(22) PCT Filed: Sep. 14, 2015
(86) PCT No.: PCT/JP2015/076073

§ 371 Date: Feb. 15, 2017

(30) Foreign Application Priority Data
Sep. 12, 2014 (JP) 2014-186012
Oct. 15, 2014 (JP) 2014-210459
Dec. 19, 2014 (JP) 2014-256886

(51) Int. Cl. B22D 27/04; B60B 21/02; B60B 3/02; B60B 3/06; B22C 9/06; B22C 9/28

(52) U.S. Cl. CPC B22D 27/04; B22C 9/06; B22C 9/28; B60B 3/02; B60B 3/06; B60B 21/02

(57) ABSTRACT

A method for manufacturing a light alloy wheel that includes a substantially annular rim part and a disc part that is joined to one edge of the rim part on an inner side and is to be attached to an axle. The method includes a molten metal pouring step for pouring a light alloy molten metal from a sprue opened into a mold cavity formed into a shape of the rim part, and a forced cooling step for, after the molten metal pouring step, forcibly cooling the light alloy molten metal poured into the mold cavity formed into the shape of the rim part such that one predetermined cooling unit of a plurality of cooling units provided along an entire circumference on an outer side or an inner side of the mold cavity formed into the shape of the rim part is first operated and an other cooling unit thereof is then operated.

### TECHNICAL FIELD

The present invention relates to a light alloy wheel formed of a light alloy such as an aluminum alloy, a method for manufacturing the same and a device for manufacturing the same.

### BACKGROUND ART

As light-alloy vehicle wheels attached to automobiles (passenger cars, etc.), aluminum wheels which are entirely formed of an aluminum alloy by a low-pressure casting method etc. are used for reducing the vehicle mass.

In manufacturing the light alloy wheels by the casting method, it is required to reduce a casting detect such as a shrinkage cavity. PTL 1 discloses an example of such manufacturing method. FIG. 14 is a schematic top view showing an upper mold-internal structure of a side-gate molding system which is provided with an upper mold, a lower mold and a pair of side molds and is used in the casting method proposed in the PTL 1. Cooling pipes 324 shown in FIG. 14 serve to air-cool ante-ingate portions S in a rim cavity C_{R}. On the other hand, mist cooling means 325 serve to mist-cool portions A in the rim cavity C_{R}. In the annular rim-forming cavity C_{R}, the portions A are 90° degrees off in a circumferential direction of the rim-forming cavity C_{R} from the ante-ingate portions S respectively connected to ingate-forming spaces 331 and are the farthest portions from the ante-ingate portions S in the circumferential direction of the rim-forming cavity C_{R}.

### CITATION LIST

### Patent Literature

### [PTL 1]

JP-A-2008-155235 (paragraph 0044 and FIGS. 1 and 3)

### SUMMARY OF INVENTION

### Technical Problem

In the prior art casting method exemplarily disclosed in PTL 1, the prevention of the shrinkage cavities on the rim part is sometimes insufficient. The shrinkage cavities formed on the rim part are likely to cause air leakage from the rim part. Therefore, a method of manufacturing a light alloy wheel is demanded in which the shrinkage cavities on the rim part are reduced as compared to the prior art technology so as to prevent the air leakage.

Thus, it is an object of the invention to provide a light alloy wheel that allows the manufacture of a light alloy wheel in which the casting defect such as the shrinkage cavities on the rim part is reduced so as to prevent the air leakage as compared to the prior art manufacturing method, as well as a method and a device for manufacturing the light alloy wheel.

### Solution to Problem

According to the first invention, a method for manufacturing a light alloy wheel that comprises a substantially annular rim part and a disc part that is joined to one edge of the rim part on an inner side and is to be attached to an axle comprises: a molten metal pouring step for pouring a light alloy molten metal from a sprue opened into a mold cavity formed into a shape of the rim part; and a forced cooling step for, after the molten metal pouring step, forcibly cooling the light alloy molten metal poured into the mold cavity formed into the shape of the rim part such that one predetermined cooling means of a plurality of cooling means provided along an entire circumference on an outer side or an inner side of the mold cavity formed into the shape of the rim part is first operated and an other cooling means thereof is then operated.

In the first invention, the forced cooling step may be performed such that one cooling means located farthest from the sprue of the plurality of cooling means is first operated and the other cooling means is then operated in sequence toward the sprue.

In the first invention, the forced cooling step may be performed by forcibly cooling the light alloy molten metal poured into the mold cavity formed into the shape of the rim part such that relative to a cooling power of the one cooling means, a cooling power of the other cooling means decreases toward the sprue.

In the first invention, an operation time of the cooling means may gradually decrease from a position farthest from the sprue toward the sprue.

In the first invention, the cooling means may comprise a coolant path, and a coolant flow rate of the cooling means may be gradually reduced from the position farthest from the sprue toward the sprue.

In the first invention, it is preferable that the light alloy molten metal poured into the mold cavity formed into the shape of the rim part in the molten metal pouring step is directionally solidified from a position farthest from the sprue toward the sprue in the forced cooling step.

In the first invention, it is preferable that the upper mold comprises a plurality of inside spaces in which the cooling means are enclosed, and at least the one cooling means is enclosed by one of the inside spaces different from the other cooling means, and it is more preferable that the cooling means are each independently enclosed by one of the inside spaces.

In the first invention, it is preferable that the rim part is cooled in the forced cooling step such that a relation of A<B is satisfied, where A is a secondary dendrite arm spacing (DAS II) by the secondary arm method of α-Al of the light alloy molten metal solidified at the position farthest from the sprue in the mold cavity formed into the shape of the rim part, and B is a DAS II in the light alloy molten metal solidified in front of the sprue.

In the first invention, it is preferable that the rim part is forcibly cooled such that A, B and C satisfy a formula (1) below, where C is DAS II in the light alloy molten metal solidified at an intermediate portion between the sprue and the position farthest from the sprue in the mold cavity formed into the shape of the rim part.

A+(B−A)×0.1<C<B−(B−A)×0.1 (1)

In the first invention, it is preferable that the rim part comprises a crossing portion with the disc part, and the plurality of cooling means are disposed along the entire circumference on the outer side or the inner side of the mold cavity formed into a shape of the crossing portion.

According to the second invention, a light alloy wheel comprises a substantially annular rim part; and a disc part that is joined to the rim part and is to be attached to an axle, wherein A, B and C satisfy a formula (2) below, where A is DAS II at a position circumferentially farthest from a position with a maximum DAS II in a cross section of the rim part orthogonal to the wheel, B is a maximum DAS II and C is DAS II at an intermediate portion between the position with the maximum DAS II and a position circumferentially farthest therefrom.

A+(B−A)×0.1<C<B−(B−A)×0.1 (2)

In the second invention, it is preferable that the rim part comprises a crossing portion with the disc part, and an average porosity of the crossing portion is not more than 1%.

According to the third invention, a device for manufacturing a light alloy wheel that comprises a substantially annular rim part and a disc part that is joined to one edge of the rim part on an inner side and is to be attached to an axle comprises: a mold comprising a cavity formed into a shape of the light alloy wheel; a sprue opened into a cavity formed into a shape of the rim part of the cavity formed into the shape of the light alloy wheel; a plurality of cooling means attached to the outer side or inner side of the mold cavity formed into the shape of the rim part along a circumferential direction; and a control means that operates such that, after the light alloy molten metal is poured from the sprue opened into the cavity formed into the shape of the rim part, of the plurality of cooling means, one cooling means located farthest from the sprue is first operated and an other cooling means thereof is then operated in sequence toward the sprue.

In the third invention, it is preferable that the cooling means comprise a cooling block with a cooling pipe and are attached to the outer side of the cavity formed into the shape of the rim part.

In addition, it is preferable that the upper mold comprises an inside space formed in a circumferential direction along the cavity formed into the shape of the rim part, and the cooling means comprise a cooling pipe arranged in the inside space, and it is more preferable that the one cooling means and the other cooling means are arranged in different ones of the inside space.

In addition, it is desirable that the control means operates such that, after the light alloy molten metal is poured from the sprue opened into the cavity formed into the shape of the rim part, of the plurality of cooling means, one cooling means located farthest from the sprue is first operated and the other cooling means thereof is then operated in sequence toward the sprue, and the control means controls an operation time or a cooling pressure of the cooling means such that relative to a cooling power of the one cooling means, a cooling power of the other cooling means decreases in sequence toward the sprue.

### Advantageous Effects of Invention

According to the inventions, it is possible to provide a high-strength light alloy wheel that allows the manufacture of a light alloy wheel in which the casting defect such as the shrinkage cavities on the rim part is reduced so as to prevent the air leakage as compared to the prior art manufacturing method, as well as a method and a device for manufacturing the light alloy wheel.

### BRIEF DESCRIPTION OF DRAWINGS

FIG. 1 is a vertical cross sectional view (a cross sectional view taken along a line B-C-D in FIG. 2) showing a mold used to implement a method for manufacturing a light alloy wheel in a first embodiment of the present invention.

FIG. 2 is a cross sectional view showing the mold taken along a line A-A in FIG. 1.

FIG. 3 is a diagram illustrating an example of the light alloy wheel.

FIG. 4 is a cross sectional view showing the light alloy wheel taken along a line D-D in FIG. 3.

FIG. 5 is a partial view showing a cavity in the mold used to cast the light alloy wheel.

FIG. 6 is a vertical cross sectional view (a cross sectional view taken along a line B-B in FIG. 7) showing an example of a mold used in a method for manufacturing a light alloy wheel in a second embodiment of the invention.

FIG. 7 is a cross sectional view taken along a line A-A in FIG. 6.

FIG. 8 is a schematic configuration diagram illustrating a casting system having the mold shown in FIG. 6.

FIG. 9 is a front view showing a cooling means provided on the mold shown in FIG. 6.

FIG. 10 is a diagram illustrating progress of solidification of molten metal poured into a rim part-forming cavity.

FIG. 11 is a diagram illustrating the operation sequence of the cooling means.

FIG. 12 is a diagram illustrating the operating conditions of the cooling means.

FIG. 13 is a cross sectional view showing an example of a preferred mold used in the method for manufacturing a light alloy wheel in the second embodiment of the invention.

FIG. 14 is a plan view showing a casting system used to implement a conventional method for manufacturing a light alloy wheel.

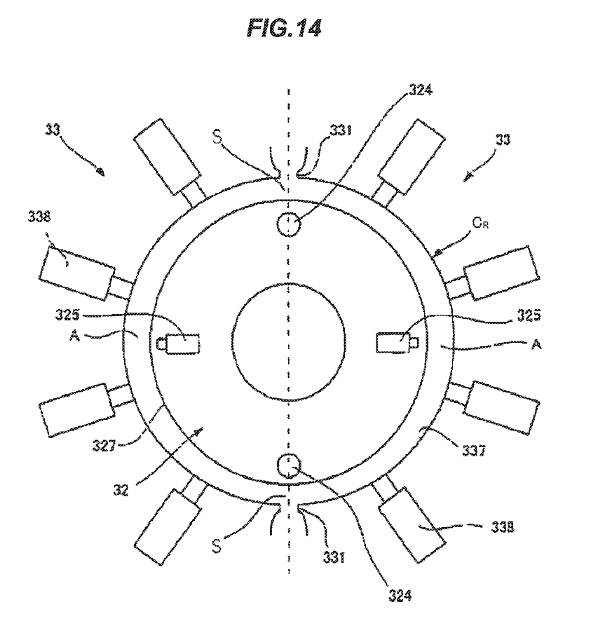

### DESCRIPTION OF EMBODIMENTS

Based on the specific embodiments, the inventions will be described in reference to the drawing. The invention, however, is not intended to be limited to the embodiments and Examples described below, and can be appropriately modified and implemented within the same scope as long as the functions and effects of the invention can be obtained.

As a result of intense study on the casting method to achieve the above-described objects, the present inventors made the present invention based on the finding that it is possible to achieve such objects when after pouring a molten metal into a cavity, plural cooling means provided on a mold to cool a rim part are operated at different timings varied according to a distance from a sprue (hereinafter, sometimes referred to as “side gate”) opened into a mold cavity having the shape of the rim part and/or according to variation in volume of the rim part in a circumferential direction.

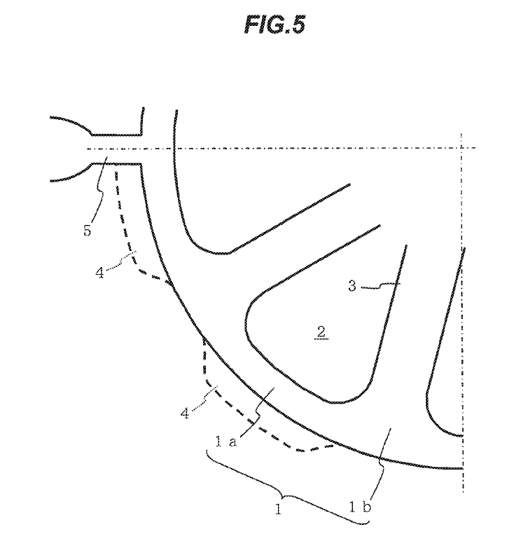

That is, a rim-part cavity 1 to be filled with a light alloy molten metal has a small-volume rim-part cavity 1a facing an aperture portion 2 and a large-volume rim-part cavity 1b facing a spoke-portion cavity 3 as shown in FIG. 5, and the cooling rate of the light alloy molten metal in the rim-part cavity 1a is faster than that in the rim-part cavity 1b due to a smaller molding space. Thus, the molten metal in the large-volume rim-part cavity 1b located farther from a side gate 5 in a circumferential direction is cooled at a slower rate than the molten metal in the small-volume rim-part cavity 1a, resulting in that directional solidification along the circumferential direction of the rim does not occur and casting defects such as shrinkage cavities may occur. For the purpose of reducing such phenomenon, extra thickness-forming spaces 4 are sometimes provided on the small-volume rim-part cavity 1a so that the rim-part cavity 1 has a smaller variation in volume in the circumferential direction. However, the extra thickness portions need to be removed by processing in a later process, which causes an increase in the manufacturing cost.

The method for manufacturing a light alloy wheel of the invention is provided to solve such problems and is for manufacturing a light alloy wheel having a substantially annular rim part and a disc part which is joined to one edge of the rim part on the inner side and is to be attached to an axle. The method includes a molten metal pouring step for pouring a light alloy molten metal from a sprue opened into a mold cavity formed into the shape of the rim part, and a forced cooling step performed after the molten metal pouring step to forcibly cool the light alloy molten metal poured into the mold cavity formed into the shape of the rim part so that one predetermined cooling means out of plural cooling means provided along the entire circumference on the outer side or inner side of the mold cavity formed into the shape of the rim part is operated first, and thereafter, the other cooling means are operated.

In the invention using such configuration, when a portion of the rim part cot located around a sprue (side gate) opened into the mold cavity having the shape of rim part, i.e., a portion of the rim cooled at a slower rate than surrounding areas and likely to remain as a localized high-temperature portion (hereinafter, sometimes referred to as “hot spot”), is cooled to a certain temperature by the one cooling means, it is possible to achieve directional solidification along the circumferential direction of the rim (hereinafter, sometimes referred to as “circumferential directional solidification”) without forming extra thickness portions. As a result, a riser effect acts on the entire rim part from the side gate and casting defects such as shrinkage cavities occurring in the rim part can be reduced as compared to the conventional manufacturing method.

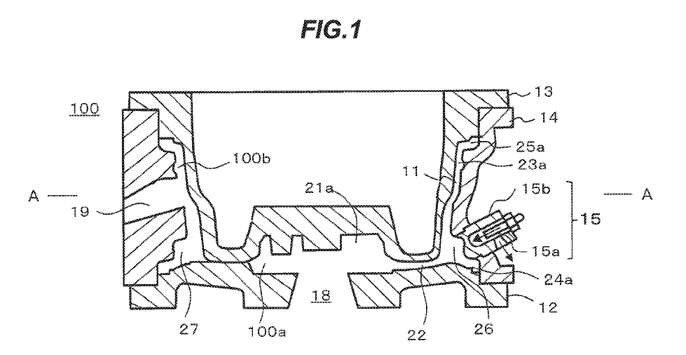

In more detail, when a light alloy wheel is formed by a casting method in which a light alloy molten metal is poured from a sprue (hereinafter, sometimes referred to as “side gate”) 19 opened into a cavity 100b which has the shape of the rim part and is defined by an upper mold 13 and a pair of movable split molds 14 as shown in FIG. 1, it is known to be preferable to induce circumferential directional solidification in which the molten metal in the rim part is solidified from the position farthest from the side gate toward the side gate along the circumferential direction, as described above. In this case, if the thickness of the rim part is uniform in the circumferential direction, the molten metal in the rim part basically tends to solidify toward the side gate without cooling control of the mold. However, when manufacturing a light allow wheel with a thinner rim part, circumferential directional solidification of the rim part is not necessarily achieved. In contrast to this, the above-described method for manufacturing a light alloy wheel allows circumferential directional solidification of the rim part to be easily achieved by using a casting system having a control unit which controls plural cooling means provided along the entire circumference in an inside space of the upper mold so that a predetermined one of the cooling means is operated at first to firstly solidify the a predetermined section of the rim part and the other cooling means are then operated to solidify the rest of the rim part. Due to such cooling control of the mold, it is possible to achieve circumferential directional solidification of the rim part without forming extra thickness portions. As a result, a riser effect acts on the entire rim part from the side gate and casting defects such as shrinkage cavities occurring in the rim part can be reduced as compared to the conventional manufacturing method.

Next, the invention will be specifically described based on the first and second embodiments. Firstly, a configuration of a light alloy wheel manufactured in the both embodiments and constituent elements of the commonly used manufacturing device and mold will be described.

### [Configuration of Light Alloy Wheel]

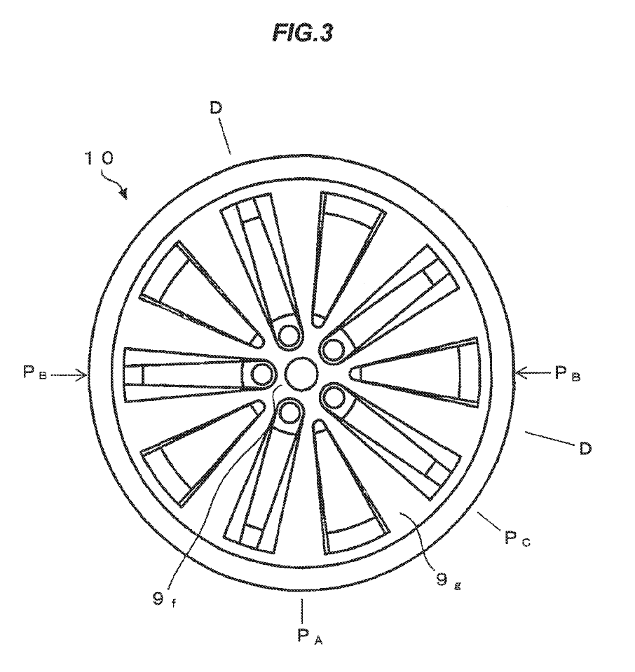

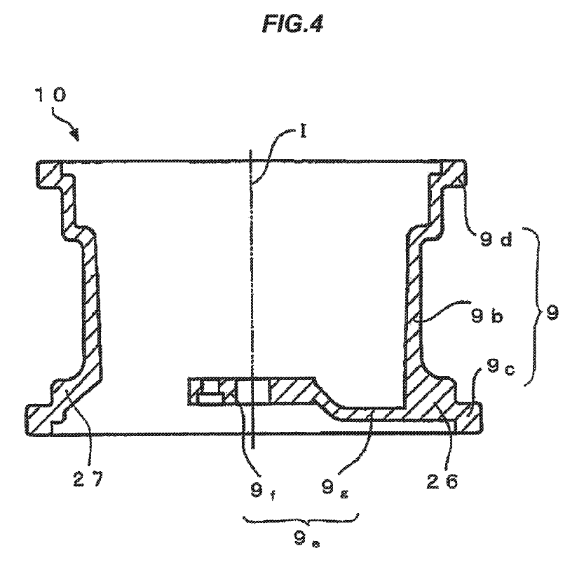

A light alloy wheel manufactured in each embodiment of the invention will be described in reference to FIGS. 3 and 4, using an aluminum wheel as an example. FIG. 3 is a bottom view showing a light alloy wheel 10 of FIG. 4. FIG. 4 is a cross sectional view taken along a line D-D in FIG. 3. Hereinafter, the center line I of the light alloy wheel 10 shown in FIG. 4 is sometimes referred to as “axial direction”, a direction orthogonal to the center line I as “radial direction” and a direction about the center line I as “circumferential direction”. As shown in FIGS. 3 and 4, the light alloy wheel 10 is composed of a disc part 9e which has a hub portion 9f and spokes 9g radiating from the outer peripheral surface of the hub portion 9f, and a rim part 9a which has a substantially annular rim main body 9b having an inner peripheral surface joined to an outer peripheral portion of the disc part 9e, an outer flange portion 9c as an example of a first flange portion arranged at a lower edge (one edge) of the rim main body 9b and an inner flange portion 9d as an example of a second flange portion arranged at an upper edge (other edge). The rim part 9a is coupled to the disc part 9e on the outer flange portion 9c side. A portion of the disc part 9e coupled to the rim part 9a is a crossing portion 26. Although the spokes 9g are provided in the embodiments, the form of the design portion is not limited to the spoke and can be various other forms such as mesh. The crossing portion is, in other words, a coupling portion between the spoke 9g and the rim part 9a. The volume of the crossing portion 26 is larger than that of a non-crossing portion 27. After a tire is mounted on the rim main body 9b so as to be sandwiched between the outer flange portion 9c and the inner flange portion 9d, the light alloy wheel 10 is attached to an axle with the disc part 9e facing outward of the vehicle body and is thereby ready for use.

### [Manufacturing Device and Mold]

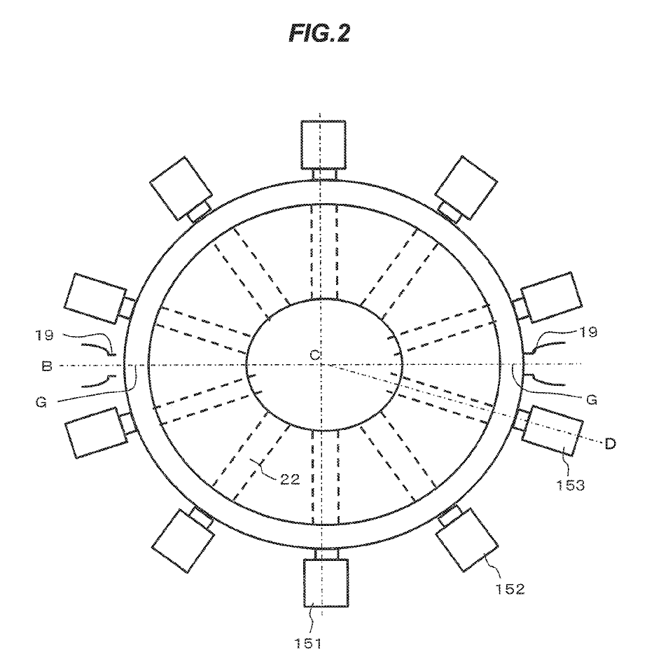

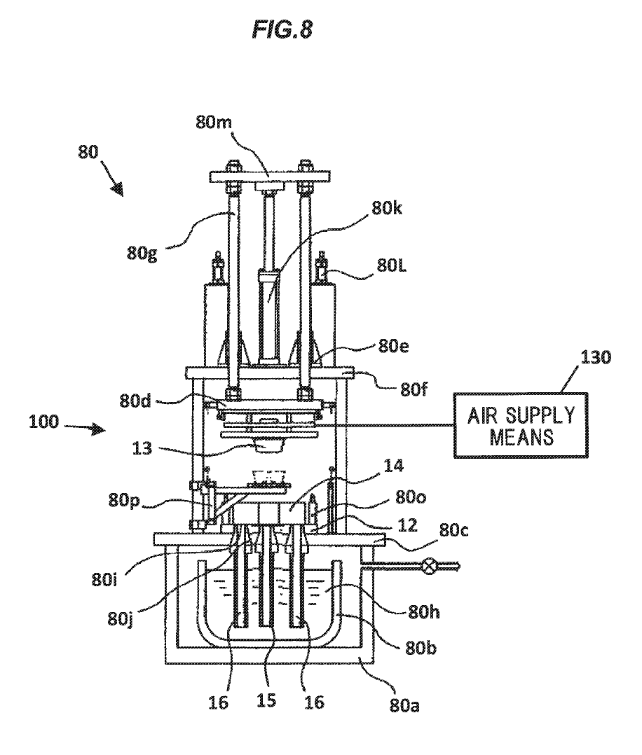

An example of a device for manufacturing the wheel having such configuration will be described in reference to FIGS. 1, 2 and 8. FIG. 1 is a vertical cross sectional view (a cross sectional view taken along a line B-C-D of FIG. 2) along an axial direction of a mold 100 which is provided in a manufacturing device used for low-pressure casting of the above-described spoke-type aluminum wheel. FIG. 2 is a cross sectional view showing the mold 100 taken in a radial direction along a line A-A of FIG. 1. FIG. 8 is a schematic configuration diagram illustrating a manufacturing device having the mold 100 shown in FIGS. 1 and 2.

As shown in FIG. 1, the mold 100 has a lower mold 12, an upper mold 13 and a pair of horizontally movable split molds 14. Once the molds are clamped and combined, a cavity (disc part cavity) 100a having the shape of the disc part 9e and a cavity (rim part cavity) 100b having the shape of the rim part 9a are formed as shown in the drawings and together constitute a cavity (product cavity) having the shape of a wheel material which includes the light alloy wheel 10 and an appropriate extra thickness (e.g., machining margin) added where necessary (hereinafter, referred to as “wheel”, including the wheel material). In addition, a sprue (hereinafter, also referred to as “center gate”) 18 opened into a hub portion cavity 21a and the side gates 19 as an example of the sprue opened to a rim main body cavity 23a of the rim part cavity 100b are formed on the mold 100, and stalks 18a and 19a as runners (see FIG. 8) are respectively connected to the center gate 18 and the side gates 19. The center gate 18 opened into the hub portion cavity 21a, however, is not essential to implement the manufacturing method of the invention and is provided when required.

The configuration of the manufacturing device provided with the mold 100 will be described. As shown in FIG. 8, a manufacturing device 80 in the embodiments is configured that a holding furnace 80b is arranged in an airtight sealed container 80a and a lower-mold platen 80c is mounted on the top of the airtight sealed container 80a to seal the airtight sealed container 80a. The stalks 18a and 19a for supplying a molten metal 80h into the mold 100 are attached to the lower-mold platen 80c to which the lower mold 12 and the pair of movable split molds 14 are attached. The lower ends of the stalks 18a and 19a are submerged in the molten metal 80h in the holding furnace 80b. The upper ends of the stalks 18a and 19a are connected to the center gate 18 and the side gates 19 of the mold 100 via sprue bushes 80j and pouring gates 80i which are inserted through the lower-mold platen 80c, the lower mold 12 and the pair of movable split molds 14. The upper mold 13 is attached to a movable platen 80d. The movable platen 80d is fixed to guide posts 80g which are vertically movable along guides 80e provided on an upper-mold platen 80f. Then, the guide posts 80g are fixed, at upper ends, to a top plate 80m, a hydraulic cylinder 80k provided on the upper-mold platen 80f moves the top plate 80m, and the movable platen 80d and the upper mold 13 accordingly move vertically. Meanwhile, the airtight sealed container 80a containing the holding furnace 80b maintaining the molten metal 80h at a constant temperature is connected to a pressurizing means (not shown) via a control valve so that the airtight sealed container 80a can be pressurized by the pressurizing means. In FIG. 8, electric jacks for slightly lifting up the upper mold 13 at the time of shakeout are denoted by a reference sign 80L, guide pins are denoted by a reference sign 80o, and a detachable arm for ejecting the light alloy wheel 10 from the upper mold 13 is denoted by a reference sign 80p.

When using the manufacturing device 80 having such configuration, clamping of the mold 100 composed of the lower mold 12, the upper mold 13 and the pair of movable split molds 14 is completed in a predetermined period of time after the start of casting. After completion of the clamping, the pressurizing means starts to pressurize the holding furnace in accordance with a preset pressurizing pattern. The molten metal 80h in the holding furnace 80b is pushed up by the pressure and is then supplied into the cavity of the mold 100 from the center gate 18 and the side gates 19 through the stalks 18a and 19a. Once the molten metal 80h reaches an inner flange portion cavity 25a and the cavity is completely filled with the molten metal 80h, pressure applied by the pressurizing means is increased for a predetermined period of time to supply more molten metal 80h so that the volume reduced by shrinkage due to solidification is refilled. After the predetermined period of time, pressure applied to the holding furnace 80b by the pressurizing means is released and the molten metal 80h remaining in the stalks 18a and 19a returns to the holding furnace 80b, thereby completing casting of the wheel.

### First Embodiment

The method and device for manufacturing the light alloy wheel in the first embodiment of the invention will be described in reference to FIGS. 1 to 4.

### [Mold and Manufacturing Device]

The mold 100 of the first aspect has plural chillers 15 as an example of plural cooling means which are provided in the movable split molds 14 on the outer side of the cavity (crossing portion-forming cavity) having the shape of the coupling (crossing) portion between the rim part and the disc part and are arranged along the entire circumference. In detail, each chiller 15 in the present aspect is constructed from a cooling block 15b with a cooling pipe 15a and has a circumferential length substantially equal to a width of a base joint of each spoke (design portion) 9g. Such chiller 15 is configured that a coolant such as cooling air or cooling water is circulated in arrow directions through the cooling pipe 15a to cool the cooling block 15b. The cooling block 15b is preferably formed of a material which has a higher thermal conductivity than a material constituting the mold and does not contaminate an aluminum alloy molten metal even when in contact with the molten metal.

The arrangement of the chillers 15 configured as described above will be described in reference to FIG. 2 which shows a cross section taken along a line A-A in FIG. 1 as viewed in an arrow direction. As shown in FIG. 2, plural chillers 151, 152 and 153 are provided at positions corresponding to the spokes 9g in the circumferential direction. The circumferential positions and number of the cooling means are appropriately determined according to the number and interval of the spokes 9g. When two side gates 19 are provided at opposite positions, the chiller 151 located 90° away from the side gates 19 in the circumferential direction is the farthest cooling means from the side gates 19, and is preferably set as the one cooling means to be firstly operated. In case that plural side gates 19 are provided, a circumferential distance between a cooling means and a side gate is the shortest of the distance between the cooling means and each side gate. The cooling means operated after the chiller 151 is desirably the chiller 152 which has a shorter distance to the side gate 19 than the chiller 151 and corresponds to one of the other cooling means. Then, the cooling means operated after the chiller 152 is desirably the chiller 153 which has a shorter distance to the side gate 19 than the chiller 152 and corresponds to one of the other cooling means. In this respect, even when two side gates 19 are provide at opposite positions as described above, the position of the cooling means located farthest from the side gate is not limited to the position 90° away from the side gates 19 in the circumferential direction. For example, depending on the design of the light alloy wheel, any spoke may not be present at a position 90° away from the side gates 19 in the circumferential direction. When such light alloy wheel is casted, the position of the farthest cooling means from the side gate 19 is different from the position 90° away from the side gates 19 in the circumferential direction. The configuration in the remaining 270° area is the same and the explanation thereof is omitted.

The rim part 9a is coupled to the spokes 9g on the disc part 9e side and the crossing portions 26 are thereby formed, as described previously. The crossing portion 26 is thicker than the non-crossing portion 27 and is thus likely to be a hot spot. In addition to the crossing portions, uneven thickness portions which are likely to be hot spots are sometimes formed for a design reason. In the present invention, the crossing portions and the uneven thickness portions are called “thick portions”.

The above-described chillers as cooling means are arranged on the outer side of the rim part cavity 100b but may be arranged on the inner side, and also may be provided on any of the lower mold 12, the upper mold 13 and the movable split molds 14 as long as they are located at positions allowing preferably the thick portions of the rim part to be cooled. In this regard, however, cooling means do not necessarily need to be provided for all thick portions, and the cooling means may not be provided at the positions corresponding to the thick portions close to the side gates 19. However, among the lower mold 12, the upper mold 13 and the movable split molds 14, the area facing the thick portions and the space for installing the cooling means are largest in the movable split molds 14 and it is thus preferable to provide cooling means on the movable split molds 14.

Also, in combination with cooling from the outer side of the rim part-forming cavity using the cooling means provided on the movable split molds as described above, it is sometimes necessary to cool from the inner side of the rim part-forming cavity in order to adequately solidify the molten metal filled in the rim part-forming cavity. The cooling from inner side of the rim part-forming cavity can be adjusted by appropriately selecting a material constituting the mold and the structure of the mold. In detail, the chillers as described above may be arranged on the upper mold, or, a cooling pipe which is a cooling means in the second embodiment described later may be arranged in an inside space provided in the upper mold.

The manufacturing device in the first embodiment has plural cooling means (chillers) as described above and is also provided with a control means for controlling the plural cooling means so that, after a light alloy molten metal is poured from the side gate 19 opened to the rim part cavity 100b, one cooling means located farthest from the side gate 19 is operated first, and the other cooling means are then operated in sequence toward the side gate 19. The control means is realized by, e.g., CPU which executes a program. Alternatively, the control means may be partially or entirely constructed from a hardware circuit such as reconfigurable circuit (Field Programmable Gate Array: FPGA) or application specific integrated circuit (ASIC).

In detail, the cooling means can be controlled by a program stored in the control means, in which, e.g., wait time, circulation duration and pressure of the coolant flowing through the cooling pipe 15a in the cooling block 15b are set for each cooling means. The coolant wait time is a period from completion of filling of the molten metal into the cavity to start of coolant circulation through the cooling pipe 15a, the circulation duration is a period from start to end of the coolant circulation, and the coolant pressure is pressure of circulating coolant. In order to operate the plural cooling means at different timings, the coolant wait time is differently programmed for each cooling means. The coolant wait time for the one cooling means to be operated first is set to the shortest, and the coolant wait time for the other cooling means is set to be longer. The coolant wait time is preferably set to the shortest for the cooling means located farther from the side gate and is increased for the other cooling means as a distance from the side gate decreases. The cooling condition setting is adjusted such that when, for example, it is considered that a thick portion is not sufficiently cooled, cooling power of the corresponding cooling means is increased by reducing the coolant wait time, increasing the circulation duration or increasing the coolant pressure, or a combination of two or more thereof. The setting can be such that cooling power of the one cooling means to be operated first is the highest and cooling power of the other cooling means to be subsequently operated decreases toward the sprue. In this case, cooling power of the other cooling means may decrease with a gradient towards the sprue.

### [Method for Manufacturing Light Alloy Wheel]

Next, a method for manufacturing a light alloy wheel using the mold 100 shown in FIG. 1 will be described. Firstly, the lower mold 12, the upper mold 13 and the pair of movable split molds 14 in FIG. 1 are clamped to form a cavity 11. Next, an aluminum alloy molten metal (equivalent to, e.g., JIS AC4CH) in a holding furnace (not shown) is injected toward the center gate 18 and the side gates 19 via the stalks by pressurizing the holding furnace to fill the disc part cavity 100a and the rim part cavity 100b. From the point where the aluminum alloy molten metal is filled up to the inner flange portion cavity 25a which is an upper end (edge) of the cavity 11, pressurization of the holding furnace is maintained for a predetermined period of time.

After making sure that the molten metal is filled up to the upper end of the cavity in the molten metal pouring step, the plural chillers 15 are operated such that the chiller 151 as the one cooling means located farthest from the side gate is operated first and the chillers 152 and 153 as the other cooling means are operated in this order, thereby forcibly cooling the light alloy molten metal poured into the mold cavity having the shape of the rim part. “Operation” of the cooling means is to make the coolant circulate through the cooling pipe 15a. As a result, the rim main body cavity 23a including the crossing portions 26 is cooled and the aluminum alloy molten metal is directionally solidified toward the side gate 19.

When it is difficult to achieve circumferential directional solidification only by operating the plural cooling means at different timings, forced cooling of the light alloy molten metal poured into the mold cavity having the shape of the rim part is desirably performed with such conditions that cooling power of the one cooling means is the highest and cooling power of the other cooling means decreases toward the side gate. It is thereby possible to achieve circumferential directional solidification more preferably.

Since cooling power of the cooling means can be adjusted by changing operation time (circulation duration), it is more desirable to gradually decrease operation time of cooling means from the position farthest from the side gate toward the side gate.

Since cooling power of the cooling means can be adjusted also by changing the coolant flow rate (coolant pressure), it is further desirable that the coolant flow rate in the cooling means with a coolant path be gradually reduced from the position farthest from the side gate toward the side gate.

After completing the forced cooling step, the molten metal is returned to the holding furnace by releasing the pressure in the holding furnace and the completely solidified wheel material is demolded.

### Second Embodiment

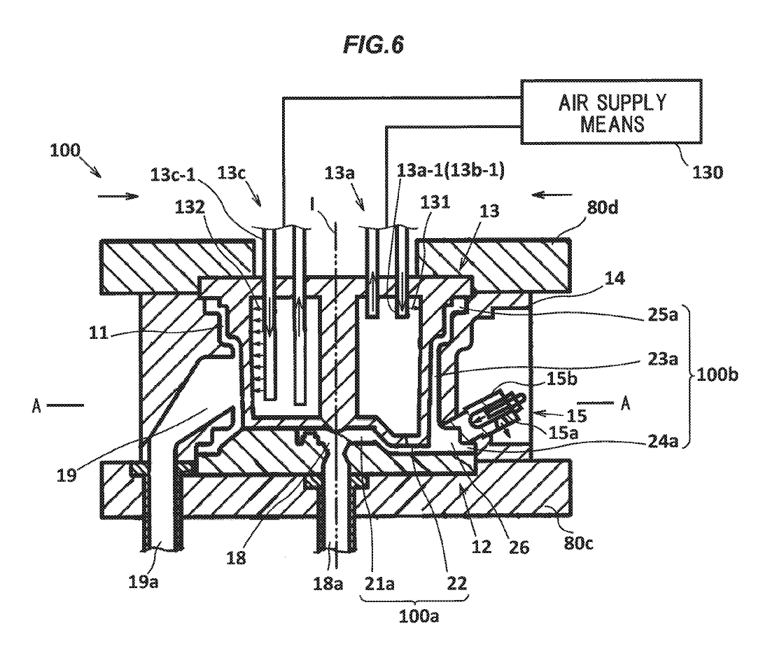

The method and device for manufacturing the light alloy wheel in the second embodiment of the invention will be described in detail in reference to FIGS. 6 to 13.

### [Manufacturing Device and Mold]

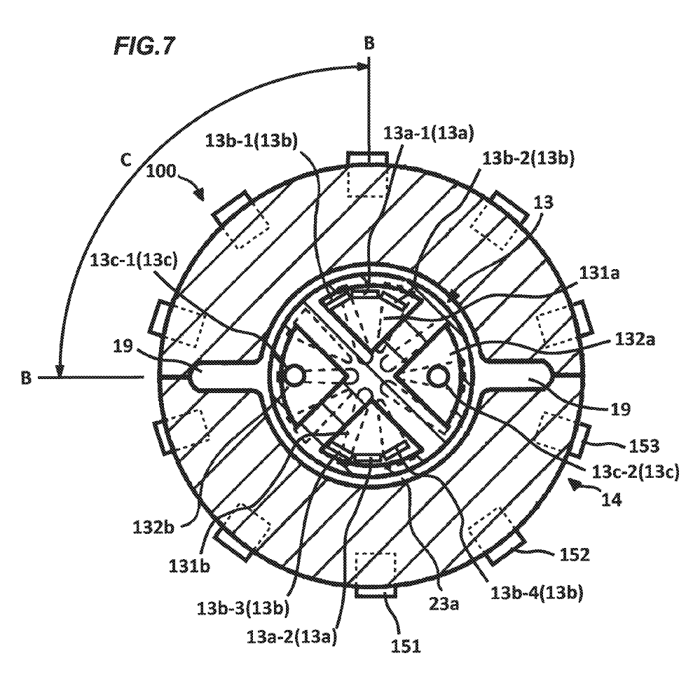

As shown in FIG. 7, the upper mold 13 of the manufacturing device in the second embodiment has two first inside spaces 131a (131) and 131b (131) which are separated 180° from each other and formed to include the positions farthest from the side gates 19, specifically, the region of about ±45° from the position 90° away from the side gates 19 in the circumferential direction. In addition, the upper mold 13 also has second inside spaces 132a (132) and 132b (132) which are separated from the first inside space 131a without overlapping the first inside space 131a or 131b and are formed to include the positions facing the side gates 19 and the vicinity thereof, e.g., the regions of about ±45° from the side gates 19. The first inside spaces 131a, 131b and the second inside spaces 132a, 132b are respectively plane-symmetrical pairs and are formed in the circumferential direction along the rim part-forming cavity so as to penetrate the upper mold 13. Furthermore, cooling pipes 13a, 13b and 13c arranged in the inside spaces 131 and 132 respectively have the same configurations (that is, for example, four cooling pipes 13b-1 to 13b-4 as the other cooling means have the same configuration) and are provided plane-symmetrically in the inside spaces 131 and 132. Therefore, regarding the first inside spaces 131, the second inside spaces 132 and the cooling pipes 13a, 13b and 13c arranged in these inside spaces, only constituent elements arranged in a quarter of the entire circumference (the range denoted by C in FIG. 7) will be described below and the explanation for the other constituent elements are omitted.

The cooling pipes 13a-1 (the one cooling means) and 13b-1 (the other cooling mean 1) provided in the first inside space 131a inject the cooling air supplied through an air supply means 130 in the first inside space 131a. The cooling pipe 13a-1 is located at the center of the first inside space 131a in the circumferential direction, i.e., at the position farthest from the side gate 19 in the circumferential direction. Meanwhile, the cooling pipe 13b-1 is located on a side of the cooling pipe 13a-1, i.e., on the side gate 19 side of the cooling pipe 13a-1 in the circumferential direction. The axial position of the cooling pipes 13a-1 and 13b-1 in the first inside space 131a corresponds to the position of the inner flange portion cavity 25a as shown in FIG. 6 so that the molten metal filled in the rim part cavity 100b is cooled from above in the axial direction (i.e., from the inner flange portion cavity 25a side). The cooling pipes 13a-1 and 13b-1 inject the cooling air toward the back side of the peripheral wall of the upper mold 13 (as indicated by an arrow in FIG. 6) to cool the peripheral wall of the upper mold 13.

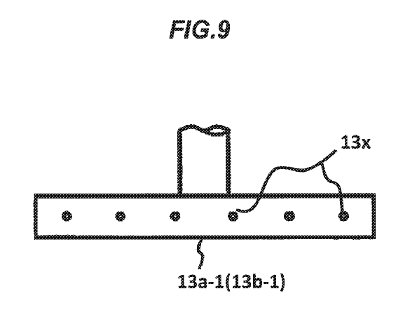

Now, referring to FIG. 9 which shows a front view of the cooling pipes 13a-1 and 13b-1, the cooling pipes 13a-1 and 13b-1 have injection holes 13x used for cooling air injection and formed at predetermined intervals along the circumferential direction and are arranged so that the injection holes 13x face the back side of the peripheral wall of the upper mold 13. The intervals of the injection holes 13x may be closer on the cooling pipe 13a-1 than on the cooling pipe 13b-1 so that the portion of the upper mold 13 located 90° away from the side gate 19 can be cooled more intensively.

As shown in FIG. 7, the cooling pipe 13c-1 (the other cooling means 2) provided in the second inside space 132b injects the cooling air supplied through the air supply means 130 in the second inside space 132b. The cooling pipe 13c-1 is arranged to face the side gate 19 in the circumferential direction. In addition, the cooling pipe 13c-1 has plural injection holes in a vertical direction, e.g., aligned in a row from the inner flange portion cavity 25a to the rim main body cavity 23a in the axial direction as shown in FIG. 6 to inject the cooling air toward the back side of the peripheral wall of the upper mold 13 at the position facing the side gate 19 (as indicated by an arrow in the drawing) to cool the peripheral wall of the upper mold 13 facing the side gate 19.

In the second embodiment, the inside space formed inside the upper mold 13 is divided into the first inside space 131a and the second inside space 132a, and the cooling pipes (the one cooling means) 13a-1 present at the position farthest from the side gate 19 is arranged in the first inside space 131a and is separated at least from the cooling pipe 13c-1 (the other cooling means 2) which is arranged in the second inside space 132a, and such configuration has the following advantageous technical significance. That is, if the cooling pipes 13a-1 to 13c-1 are arranged in the same inside space, the cooling air injected from the firstly-operated cooling pipe 13a-1 causes substantially simultaneous cooling of the entire upper mold 13, not pinpoint cooling of the peripheral wall of the upper mold 13 at the position farthest from the side gate 19. If the entire upper mold 13 is cooled substantially simultaneously, it is difficult to achieve desired circumferential directional solidification. In contrast, when the inside space is divided into the first inside space 131a and the second inside space 132a so that the cooling pipes 13a-1 and 13b-1 are provided in the first inside space 131a and the cooling pipe 13c-1 in the second inside space 132b as is in the second embodiment, the cooling air injected from the cooling pipes 13a-1 and 13b-1 stay inside the first inside space 131a and preferentially cools the peripheral wall of the upper mold 13 at which the first inside space 131a is present. Thus, the portion of the peripheral wall of the upper mold 13 facing the side gate 19 is prevented from being cooled at the same time and is cooled by the cooling air injected from the cooling pipe 13c-1 arranged inside the second inside space 132b. Such configuration, in which the cooling pipes 13a-1 as the one cooling means and the cooling pipe 13c-1 as the other cooling means arranged at a position corresponding to the side gate are provided in separate inside spaces, is preferable since circumferential directional solidification is achieved more easily.

To adequately solidify the molten metal filled in the rim part-forming cavity, it is sometimes necessary to cool from the outer side of the rim part-forming cavity in combination with the cooling from the inner side of the rim part-forming cavity using the cooling means (cooling pipe) provided on the upper mold as described above. The cooling from the outer side of the rim part-forming cavity can be adjusted by appropriately selecting a material constituting the mold and the structure of the mold, and the mold 100 of the second embodiment is configured that the plural chillers 15 are provided in the movable split molds 14 on the outer side of the crossing portion-forming cavity so as to be arranged along the entire circumference. In detail, each chiller 15 in the present aspect is constructed from the cooling block 15b with the cooling pipe 15a and has a circumferential length substantially equal to a width of a base joint of each spoke (design portion) 9g. Such chiller 15 is configured that a coolant such as cooling air or cooling water is circulated in arrow directions through the cooling pipe 15a to cool the cooling block 15b. The cooling block 15b is preferably formed of a material which has a higher thermal conductivity than a material constituting the mold and does not contaminate an aluminum alloy molten metal even when in contact with the molten metal.

In a 90° section from the side gate portion in the circumferential direction, the chillers 15 configured as described above are arranged as shown in FIG. 7 which is a cross section taken along a line A-A in FIG. 6 as viewed in an arrow direction, i.e., the plural chillers 151, 152 and 153 are provided at positions corresponding to the spokes 9g in the circumferential direction. The configuration in the remaining 270° area is the same and the explanation thereof is omitted.

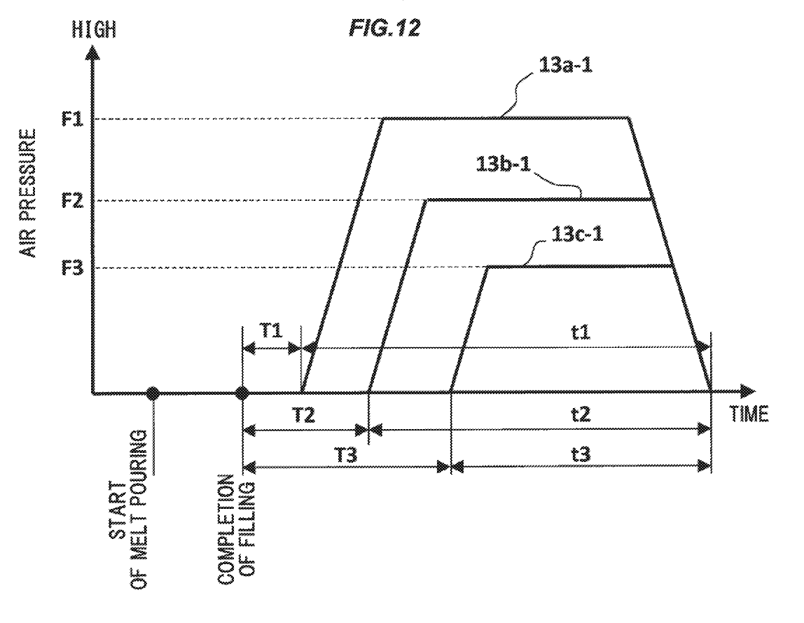

Various conditions of coolant (cooling air) injected from the cooling pipes 13a-1 to 13c-1, e.g., the cooling conditions such as wait time until injection of the cooling air (hereinafter, sometimes referred as “injection wait time”), injection duration of the cooling air and pressure of the cooling air are independently set for each of the cooling pipes 13a-1 to 13c-1 and controlled by a program. The injection wait time is a period from completion of filling of the molten metal into the cavity to start of air injection and is indicated by T1 to T3 in FIG. 12, the air injection duration is a period from start to end of the air injection and is indicated by t1 to t3, and the air pressure is pressure of the cooling air as an example of the coolant pressure and is indicated by F1 to F3.

The manufacturing device in the second embodiment having the cooling means as described above is also provided with a control means which controls the plural cooling means so that, after a light alloy molten metal is poured from the side gate 19 opened to the rim part cavity 100b, one cooling means located farthest from the side gate 19 is operated first and the other cooling means are then operated in sequence toward the side gate 19, and the control means also controls operation time or cooling pressure of the cooling means so that cooling power of the one cooling means is the highest and cooling power of the other cooling means decreases in sequence toward the side gate 19. The control means is realized by, e.g., CPU which executes a program. Alternatively, the control means may be partially or entirely constructed from a hardware circuit such as FPGA or ASIC.

### [Method for Manufacturing Light Alloy Wheel]

The method for manufacturing a light alloy wheel in the second embodiment of the invention includes a molten metal pouring step in which, from the side gate (sprue) 19 opened to the cavity 100b having the shape of the rim part and defined by the upper mold 13 and the pair of movable split mold 14, a light alloy molten metal is poured into the cavity 11 which has the shape of the light alloy wheel and is formed in the mold 100 having the upper mold 13, the lower mold 12 and the pair of movable split molds 14 as shown in FIGS. 6 and 7. In this manufacturing method, a forced cooling step is further performed after the molten metal pouring step to forcibly cool the light alloy molten metal (hereinafter, sometimes referred to as “molten metal”) poured into the cavity having the shape of the rim part (hereinafter, sometimes referred to as “rim part-forming cavity”, other cavities are also called in the similar manner) so that, among the cooling pipes 13a to 13c as the plural cooling means provided in the inside spaces 131 and 132 of the upper mold 13 and arranged along the entire circumference, the cooling pipe 13a as the predetermined one cooling means is operated first and the cooling pipes 13b and 13c as the other cooling means are then operated.

In detail, firstly, the lower mold 12, the upper mold 13 and the pair of movable split molds 14 in FIG. 6 are clamped to form a cavity. Next, the molten metal 80h contained in the holding furnace 80b is injected into the disc part cavity 100a and the rim part cavity 100b from the center gate 18 and the side gates 19 via the stalks 18a and 19a by pressurizing the airtight sealed container 80a (see FIG. 8). From the point where the aluminum alloy molten metal is filled up to the inner flange portion cavity 25a which is an upper end of the cavity, pressurization of the holding furnace 80b is maintained for a predetermined period of time (the molten metal pouring step).

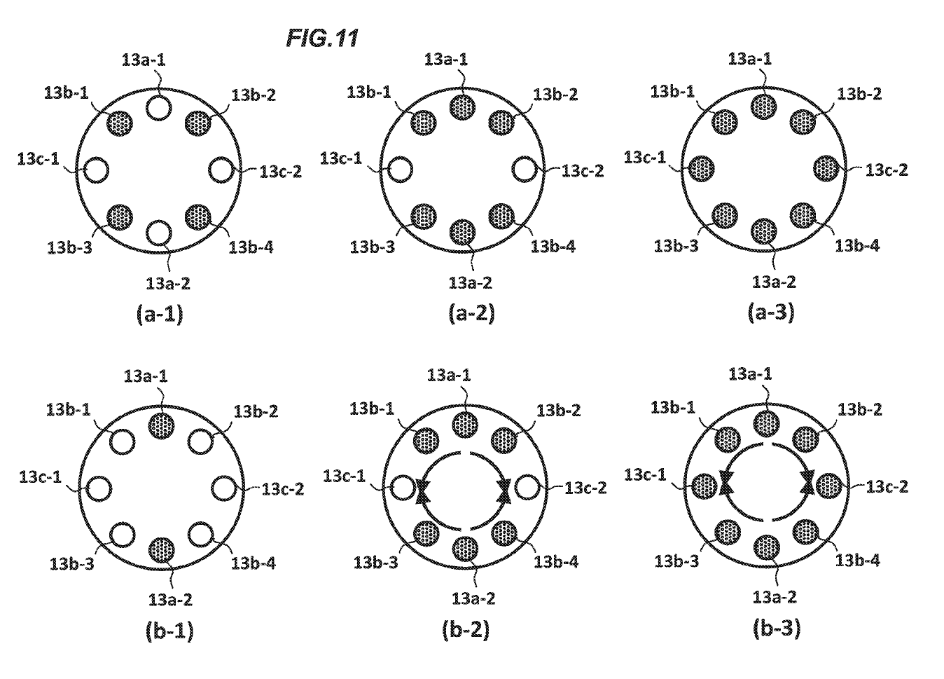

After the molten metal is filled up to the inner flange portion cavity 25a in the molten metal pouring step, the forced cooling step is performed by operating the cooling pipes (cooling means) 13a-1 to 13c-1 so that the cooling air is circulated through and injected from the cooling pipes 13a-1 to 13c-1. The forced cooling step here may be performed such that the cooling pipes 13b-1 are firstly operated as the one cooling means as shown in FIG. 11 (a-1) (in the drawing, the operating cooling means are indicated by a solid circle, the same applies to the other drawings in FIG. 11) and the cooling pipes 13a-1 and 13c-1 are then operated in this order as shown in FIG. 11 (a-2) and (a-3). However, in order to effectively achieve circumferential directional solidification, the forced cooling of the molten metal filled in the rim part cavity 100b is preferably performed such that the cooling pipes 13a-1 located farthest from the side gates 19 are set as the one cooling means and are operated first (FIG. 11 (b-1)), and the cooling pipes 13b-1 as the other cooling mean 1 are then operated (FIG. 11 (b-2)) followed by the cooling pipes 13c-1 as the other cooling mean 2 (FIG. 11 (b-3)).

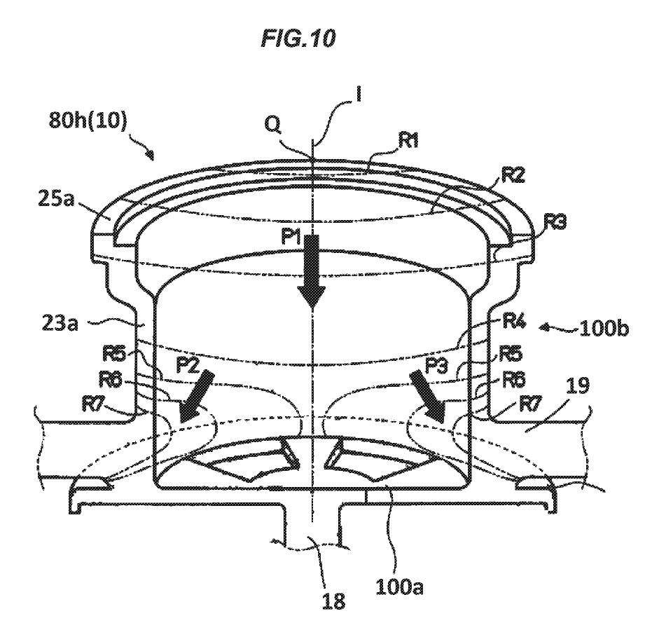

Circumferential directional solidification of the molten metal filled in the rim-part cavity 100b which is achieved by the above-described manufacturing method will be described in reference to FIG. 10. FIG. 10 conceptually shows solidification process of the molten metal in the forced cooling step and is a perspective cross-sectional view showing only the molten metal 80h filled in the disc part cavity 100a, the rim part cavity 100b, the center gate 18 and the side gates 19 in FIGS. 6 and 7, and does not show the components of the casting system such as the upper mold 13 and the lower mold 12 for better understanding. In addition, in FIG. 10, dash-dot-dot lines R1 to R7 in the form of contour lines show distribution of solidus at the time of the solidification of the molten metal 80h. In detail, each of the lines R1 to R7 is a line connecting points at which the molten metal 80h after completely filled in the rim part cavity 100b substantially simultaneously reaches solidus in the forced cooling step.

In the mold 100 having the cooling pipes 13a to 13c configured as described above, solidification of the molten metal 80h filled in the rim part cavity 100b through the side gates 19 progresses as described below. That is, the solidification of the molten metal 80h filled in the rim part cavity 100b starts at the position farthest from the side gates 19 when cooled by the cooling pipe (the one cooling means) 13a-1 which is operated first. In the second embodiment, the solidification of the molten metal 80h starts at a point Q which a circumferentially middle portion between a pair of side gates 19 as well as an axial position corresponding to the inner flange portion cavity 25a arranged at an upper end. The molten metal 80h started to solidify at the point Q of the upper portion then gradually solidifies when cooled by the cooling pipe 13b-1 (the other cooling means 1) and the cooling pipe 13c-1 (the other cooling means 2) while orienting from the inner flange portion cavity 25a down to the side gates 19 from the line R1 toward the line R7 as indicated by the arrows P1 to P3. As such, in the manufacturing method in the embodiments of the invention, it is possible to achieve desired circumferential directional solidification which progresses from the position farthest from the side gate 19 towards the side gate 19.

In order to operate the cooling pipes 13a-1 to 13c-1 at different timings, the program is made so that, for example, injection wait times T1 to T3 for the cooling pipes 13a-1 to 13c-1 are different from each other as shown in FIG. 12. In detail, the injection wait time T1 for the cooling pipe 13a-1 to be operated first is set to the shortest and the injection wait times T2 and T3 for the cooling pipes 13b-1 and 13c-1 are longer than the injection wait time T1. It is more preferable to set so that the injection wait time T1 for the cooling pipe 13a-1 located farthest from the side gate 19 is the shortest and the injection wait times T2 and T3 for the cooling pipes 13b-1 and 13c-1 are sequentially increased as the distance to the side gate 19 decreases.

In order to achieve circumferential directional solidification more effectively, it is desirable to set so that cooling power of the cooling pipe 13a-1 is the highest and cooling power of the cooling pipes 13b-1 and 13c-1 decreases toward the side gate 19. In detail, it is possible to realize it when injection durations t1 to t3 of the cooling air injected from the cooling pipes 13a-1 to 13c-1 gradually decrease (preferably in a gradient manner) in this order or when the air pressures F1 to F3 gradually decrease (preferably in a gradient manner) in this order.

After completing the forced cooling step, the molten metal 80h is returned to the holding furnace 80b by releasing the pressure in the holding furnace 80b, the completely solidified wheel material is taken out of the mold 100 and, if required, is appropriately treated by, e.g., processing or painting, etc. A desired wheel is thereby obtained.

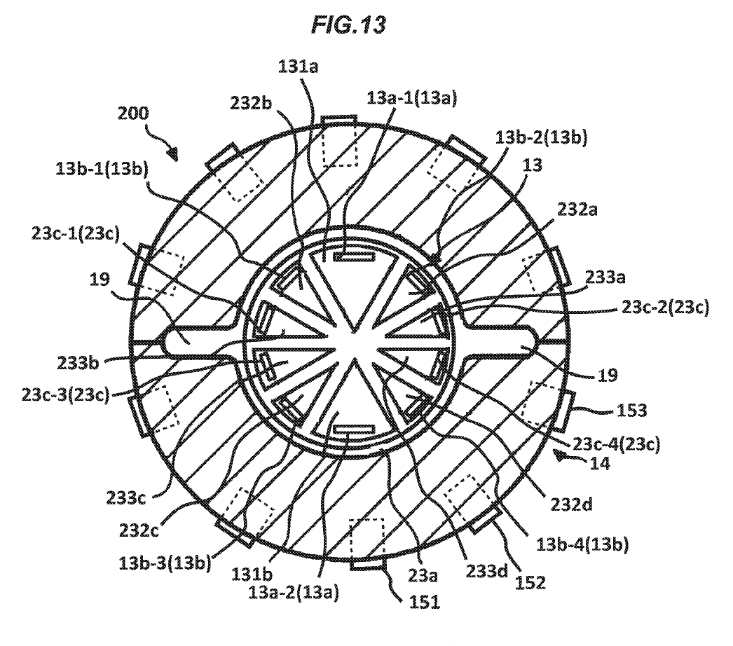

FIG. 13 is a cross sectional view showing an example of a preferred mold 200 used in the manufacturing method in the second embodiment of the invention. The preferred mold 200 is different from the mold 100 in the second embodiment in that (1) the cooling pipes 13a-1, 13b-1 and 23c-1 are individually housed, one in each of first to third inside spaces 131a, 232b and 233b which are three separate inside spaces, and (2) the cooling pipes 23c-1 arranged in the third inside space 233b so as to face the side gate 19 has the same configuration as the cooling pipes 13a-1 and 13b-1. By using the mold 200 of the second embodiment which is a preferred example, it is possible to achieve circumferential directional solidification more effectively.

### [Product Characteristics]

The light alloy wheel of the invention has a substantially annular rim part and a disc part joined to one edge of the rim part on the inner side and to be attached to an axle, and is characterized in that A, B and C satisfy the formula (2): A+(B−A)×0.1<C<B−(B−A)×0.1, where A is DAS II at a position circumferentially farthest from a position with the maximum DAS II on the cross section of the rim part taken orthogonal to the wheel, B is the maximum DAS II and C is DAS II at an intermediate portion between the position with the maximum DAS II and a position circumferentially farthest therefrom. Since the values of DAS II in the respective sections of the rim part have such specific relation, the light alloy wheel of the invention has fewer casting defects such as shrinkage cavities occurring in the rim part, has higher strength and causes less air leakage than the conventional light alloy wheels. The light alloy wheel which is more advantageous in terms of strength and air leakage can be obtained when porosity of the crossing portion is not more than 1%.

### Examples 1 to 5 and Comparative Example 1

Next, Examples 1 to 5 which correspond to the first embodiment will be described in comparison with Comparative Example 1. Light alloy wheels were made through the molten metal pouring step in which a casting aluminum alloy molten metal equivalent to AC4CH defined by JIS H 5202 is poured as a light alloy molten metal from the side gate 19 opened into the mold cavity shown in FIGS. 1 and 2, and the forced cooling step in which the light alloy molten metal poured into the cavity is forcibly cooled as follows. The chillers 151, 152 and 153 shown in FIG. 2 were operated at respectively different timings in Examples 1 to 5. In Examples 1, 3 and 4, the chiller 151 as the one cooling means was firstly operated at the base time point which is the time point at which pouring of the light alloy molten metal into all cavities in the mold 100 was completed, and 10 seconds later, the chillers 152 and 153 as the other cooling means were simultaneously operated. In Example 2, the chiller 151 as the one cooling means located farthest from the side gate was operated at the base time point, the chiller 152 as the other cooling means was operated 5 seconds after the base time point, and the chiller 153 as the yet other cooling means was operated 10 seconds after the base time point. In Example 3, the circulation duration (a period in which the cooling air is continuously supplied) for the chillers 151, 152 and 153 was respectively 140, 120 and 100 seconds. In Example 4, the pressure of the cooling air supplied to the chillers 151, 152 and 153 was respectively 2, 1.5 and 1 (×10⁴ Pa). In Example 5, the chillers 151 and 152 were operated at the base time point, the chiller 153 was operated 10 seconds after the base time point, and the pressure of the cooling air supplied to the chillers 151, 152 and 153 was respectively 2, 1.5 and 1 (×10⁴ Pa). In Comparative Example 1, the light alloy wheel was made under the same manufacturing conditions as in Example 1, except that all the chillers 151, 152 and 153 were operated at the base time point. Meanwhile, the cooling pipes described in the second embodiment were used as the cooling means for cooling the upper mold in Examples 1 to 5 and Comparative Example 1. The operating conditions of the cooling pipes were the same in Examples 1 to 5 and Comparative Example 1 and were as described below: the one cooling means (cooling pipe) 13a located farthest from the side gate 19 shown in FIG. 7 and the other cooling means (cooling pipes) 13b and 13c located closer to the side gate were simultaneously operated 5 seconds after the base time point. The circulation duration of the coolant (air) supplied to the cooling pipes was 100 seconds for the cooling pipes 13a and 13b and 50 seconds for the cooling pipe 13c. The coolant pressure was 2×10⁴ Pa for the cooling pipes 13a and 13b and 4×10⁴ Pa for the cooling pipe 13c.

The obtained light alloy wheels were subjected to measurements of secondary dendrite arm spacing (hereinafter, sometimes referred to as DAS II) in α-Al of the rim part (measurement of secondary arm spacing), average porosity of the crossing portion and air leakage rate. The measurement methods will be described in reference to FIGS. 3 and 4. Where the side gate portion P_{B} was defined as a reference, the position farthest therefrom as P_{A} and the intermediate position as P_{C}, the rim part was cut at each position along a plane through the rotation axis of the light alloy wheel and DAS II was derived from the photographed cross sections. A portion at the center of the rim part length in the axial direction as well as at the center of the thickness direction was photographed on each cross section, with the photographing area of 5 mm×5 mm. The porosity of the crossing portion was measured on the crossing portion 26 in the cross sections used for DAS II measurement. Using the measured data from given five points on the crossing portion 26, a ratio of the total area of pores having the maximum size of not less than 0.1 mm with respect to the 5 mm×5 mm cross section of the structure in the image (area ratio) was defined as porosity and the average of porosities obtained from the cross sections was defined as the average porosity. Air leakage was measured by a method in accordance with JASO standard C614 8.5 (Society of Automotive Engineers of Japan). The air leakage rate (percentage, %) is the value obtained by dividing the number of wheels with air leakage by the number of measured wheels and then multiplying by 100. Table 1 shows the manufacturing conditions and DAS II, average porosity and air leakage rate of the obtained light alloy wheels. In the evaluation of the air leakage rate shown in Table 1, the air leakage rate (percentage, %) in Comparative Example 1 was defined as a reference and the value obtained by subtracting the air leakage rate in each Example from the reference was evaluated into three ranks; more than 0 and not more than 0.1 (Δ), more than 0.1 and not more than 0.2 (◯) and more than 0.2 (⊚). The same measurement methods as described above were used in Examples 6 to 13 and Comparative Examples 2 and 3 described later.

TABLE 1

| | | Cooling by chillers | | | | | | | | | | | | | | | |
|---|---|---|---|---|---|---|---|---|---|---|---|---|---|---|---|---|---|
| | | | | | Circulation | | | Air | | | | | | | | | |
| | Operation | Wait time | | | duration | | | pressure | | | | | | P_{A} + | P_{B} − | Average | Air |
| | sequence of | (sec) | | | (sec) | | | (×10⁴ Pa) | | | DAS II | | | (P_{B} − P_{A}) × | (P_{B} − P_{A}) × | porosity | leakage |
| | chillers | a | b | c | a | b | C | a | b | c | P_{A} | P_{B} | P_{C} | 0.1 | 0.1 | (%) | rate |
| Example 1 | 151→152, 153 | 0 | 10 | 10 | 100 | 100 | 100 | 1 | 1 | 1 | 80 | 98 | 105 | 82.5 | 102.5 | 0.8 | Δ |
| Example 2 | 151→152→153 | 0 | 5 | 10 | 100 | 100 | 100 | 1 | 1 | 1 | 82 | 90 | 100 | 83.8 | 98.2 | 0.4 | ◯ |
| Example 3 | 151→152, 153 | 0 | 10 | 10 | 140 | 120 | 100 | 1 | 1 | 1 | 75 | 92 | 103 | 77.8 | 100.2 | 0.5 | ◯ |
| Example 4 | 151→152, 153 | 0 | 10 | 10 | 100 | 100 | 100 | 2 | 1.5 | 1 | 72 | 93 | 102 | 75.0 | 99.0 | 0.4 | ◯ |
| Example 5 | 151, 152→153 | 0 | 0 | 10 | 100 | 100 | 100 | 2 | 1.5 | 1 | 71 | 76 | 103 | 74.2 | 99.8 | 1.0 | Δ |
| Comparative | 151, 152, 153 | 0 | 0 | 0 | 100 | 100 | 100 | 1 | 1 | 1 | 81 | 82 | 97 | 82.6 | 95.4 | 1.6 | — |
| Example 1 | | | | | | | | | | | | | | | | | (reference) |

In the light alloy wheels in Examples 1 to 5, circumferential directional solidification in the rim part was achieved as understood from the DAS II values, and casting defects such as shrinkage cavities occurring in the rim part were less than the light alloy wheel in Comparative Example 1 manufactured by the conventional method as understood from the average porosity. It was found that the air leakage rate of the light alloy wheel was improved in all of Examples 1 to 5 as compared to Comparative Example 1. In the light alloy wheel in Comparative Example 1, circumferential directional solidification of the rim part was imperfect and the average porosity was slightly higher than Examples 1 to 5. The air leakage rate of the light alloy wheel in Comparative Example 1 was not sufficiently small in view of productivity.

It was found that it is preferable to forcibly cool the molten metal poured into the rim part cavity 100b by performing the forced cooling step so that a relation A<B is satisfied, where A is DAS II in the molten metal solidified in the position P_{A} farthest from the side gate 19 in the rim part cavity 100b and B is DAS II in the molten metal solidified in the position P_{B} in front of the side gate.

Furthermore, it was also found that it is preferable to forcibly cool the molten metal poured into the rim part cavity 100b by performing the forced cooling step so that A, B and C satisfy the formula (1) below, where C is DAS II in the light alloy molten metal solidified in the intermediate portion between the side gate 19 and the position farthest from the side gate 19 in the rim part cavity 100b.

A+(B−A)×0.1<C<B−(B−A)×0.1 (1)

In addition, it was found that the light alloy wheel is preferably configured so that A, B and C satisfy the formula (2) below, where A is DAS II at a position circumferentially farthest from a position with the maximum DAS II on the cross section of the rim part taken orthogonal to the wheel, B is the maximum DAS II and C is DAS II at an intermediate portion between the position with the maximum DAS II and a position circumferentially farthest therefrom.

A+(B−A)×0.1<C<B−(B−A)×0.1 (2)

### Examples 6 to 9 and Comparative Example 2

Next, Examples 6 to 9 which correspond to the second embodiment will be described in comparison with Comparative Example 2. Light alloy wheels were made through the molten metal pouring step in which a casting aluminum alloy molten metal equivalent to AC4CH defined by JIS H 5202 is poured as a light alloy molten metal from the side gate 19 opened into the mold cavity shown in FIGS. 6 and 7, and the forced cooling step in which the light alloy molten metal poured into the cavity is forcibly cooled as follows. In Example 6, the one cooling means (cooling pipe) 13a located farthest from the side gate 19 shown in FIG. 7 was firstly operated 5 seconds after the base time point, the other cooling means (cooling pipe) 13b located closer to the side gate 19 was operated 10 seconds later, and the yet other cooling means (cooling pipe) 13c facing the side gate 19 was operated 50 seconds later. In Examples 7, 8 and 9, the cooling pipe 13a was firstly operated at the base time point, the cooling pipe 13b was operated 5 seconds later, and the cooling pipe 13c was operated 50 seconds later. In Example 8, the circulation duration (a period in which the cooling air is continuously supplied) for the cooling pipes 13a, 13b and 13c was respectively 140, 120 and 100 seconds. In Example 9, the pressure of the cooling air supplied to the cooling pipes 13a, 13b and 13c was respectively 3, 2 and 4 (×10⁴ Pa). In Comparative Example 2, the light alloy wheel was made under the same manufacturing conditions as in Comparative Example 1. In Examples 6 to 9 and Comparative Example 2, the chillers described in the first embodiment were used as the cooling means for cooling the crossing portion. The operating conditions of the chillers were the same in Examples 6 to 9 and Comparative Example 2 and were as described below: all the chillers 151, 152 and 153 were operated at the base time point. The coolant (air) was supplied to the chillers 151, 152 and 153 under the conditions of circulation duration of 100 seconds and pressure of 1×10⁴ Pa.

The obtained light alloy wheels were subjected to measurements of DAS II in the rim part, average porosity of the crossing portion and air leakage rate. Table 2 shows the manufacturing conditions and DAS II, average porosity and air leakage rate of the obtained light alloy wheels.

TABLE 2

| | | Cooling means | | | | | | | | |
|---|---|---|---|---|---|---|---|---|---|---|
| | Operation | | | | Circulation | | | Air | | |
| | sequence of | Wait time | | | duration | | | pressure | | |
| | cooling | (sec) | | | (sec) | | | (×10⁴ Pa) | | |
| | means | 13a | 13b | 13c | 13a | 13b | 13c | 13a | 13b | 13c |
| Example 6 | 13a→13b→ | 5 | 10 | 50 | 100 | 100 | 100 | 2 | 2 | 4 |
| | 13c | | | | | | | | | |
| Example 7 | 13a→13b→ | 0 | 5 | 50 | 100 | 100 | 100 | 2 | 2 | 4 |
| | 13c | | | | | | | | | |
| Example 8 | 13a→13b→ | 0 | 5 | 50 | 140 | 120 | 100 | 2 | 2 | 4 |
| | 13c | | | | | | | | | |
| Example 9 | 13a→13b→ | 0 | 5 | 50 | 100 | 100 | 100 | 3 | 2 | 4 |
| | 13c | | | | | | | | | |
| Comparative | 13a, 13b, | 5 | 5 | 5 | 100 | 100 | 50 | 2 | 2 | 4 |
| Example 2 | 13c | | | | | | | | | |

| | | | | | | Average | Air |
|---|---|---|---|---|---|---|---|
| | DAS II | | | P_{A} + (P_{B} − P_{A}) × | P_{B} − (P_{B} − P_{A}) × | porosity | leakage |
| | P_{A} | P_{B} | P_{C} | 0.1 | 0.1 | (%) | rate |
| Example 6 | 82 | 85 | 105 | 84.3 | 102.7 | 0.7 | Δ |
| Example 7 | 78 | 86 | 100 | 80.2 | 97.8 | 0.4 | ◯ |
| Example 8 | 75 | 83 | 95 | 77.0 | 93.0 | 0.5 | ◯ |
| Example 9 | 72 | 81 | 97 | 74.5 | 94.5 | 0.4 | ◯ |
| Comparative | 81 | 82 | 97 | 82.6 | 95.4 | 1.6 | — |
| Example 2 | | | | | | | (reference) |

In the light alloy wheels in Examples 6 to 9, circumferential directional solidification in the rim part was achieved as understood from the DAS II values, and casting defects such as shrinkage cavities occurring in the rim part were less than the light alloy wheel in Comparative Example 2 manufactured by the conventional method. It was found that the air leakage rate of the light alloy wheel was improved in all of Examples 6 to 9 as compared to Comparative Example 2. In Comparative Example 2, circumferential directional solidification of the rim part was imperfect and the light alloy wheel had somewhat more casting defects such as shrinkage cavities in the rim part than the light alloy wheels made by the manufacturing methods used in Examples 6 to 9.

It was found that it is preferable to forcibly cool the molten metal poured into the rim part cavity 100b by performing the forced cooling step so that a relation A<B is satisfied, where A is DAS II in the light alloy molten metal solidified in the position farthest from the side gate 19 in the rim part cavity 100b and B is DAS II in the light alloy molten metal solidified in front of the side gate 19.

Furthermore, it was also found that it is preferable to forcibly cool the molten metal poured into the rim part cavity 100b by performing the forced cooling step so that A, B and C satisfy the formula (1) below, where C is DAS II in the light alloy molten metal solidified in the intermediate portion between the side gate 19 and the position farthest from the side gate 19 in the rim part cavity 100b.

A+(B−A)×0.1<C<B−(B−A)×0.1 (1)

In addition, it was found that the light alloy wheel is preferably configured so that A, B and C satisfy the formula (2) below, where A is DAS II at a position circumferentially farthest from a position with the maximum DAS II on the cross section of the rim part taken orthogonal to the wheel, B is the maximum DAS II and C is DAS II at an intermediate portion between the position with the maximum DAS II and a position circumferentially farthest therefrom.

A+(B−A)×0.1<C<B−(B−A)×0.1 (2)

### Examples 10 to 13 and Comparative Example 3

Next, Examples 10 to 13 using the preferred mold 200 in the second embodiment will be described in comparison with Comparative Example 3. Wheels were made through the molten metal pouring step in which a casting aluminum alloy molten metal equivalent to AC4CH defined by JIS H 5202 is poured as a molten metal from the side gate 19 opened into the cavity of the mold 200 shown in FIG. 13, and the forced cooling step in which the molten metal poured into the cavity is forcibly cooled as follows. In Example 10, the cooling air injection duration was 100 seconds for all the cooling pipes 13a, 13b and 13c, the pressure was 2×10⁴ Pa for the cooling pipes 13a and 13b and 4×10⁴ Pa for the cooling pipe 13c, the cooling pipe 13a located farthest from the side gate 19 was firstly operated 5 seconds after at the base time point, the cooling pipe 13b located closer to the side gate 19 was operated 20 seconds later, and the cooling pipe 23c facing the side gate 19 was operated 50 seconds later. The wheels in Examples 11, 12 and 13 were made under the same manufacturing conditions as in Example 10, except that the cooling pipe 13a was firstly operated at the base time point, the cooling pipe 13b was operated 10 seconds later and the cooling pipe 23c was operated 50 seconds later. The wheel in Example 12 was made under the same manufacturing conditions as in Example 11, except that the injection duration for the cooling pipes 13a, 13b and 13c was respectively 140 seconds, 120 seconds and 100 seconds. The wheel in Example 13 was made under the same manufacturing conditions as in Example 11, except that pressure of the cooling air supplied to the cooling pipes 13a, 13b and 23c was respectively 3×10⁴ Pa, 2×10⁴ Pa and 4×10⁴ Pa. In Comparative Example 3, the wheel was made under the same manufacturing conditions as in Comparative Example 1. In Examples 10 to 13 and Comparative Example 3, the chillers were used as the cooling means for cooling the crossing portion. The operating conditions of the chillers were the same in Examples 10 to 13 and Comparative Example 3, which were the same as those in Examples 6 to 9 and Comparative Example 2.

The obtained light alloy wheels were subjected to measurements of DAS II in the rim part, average porosity of the crossing portion and air leakage rate. Table 3 shows the manufacturing conditions and DAS II, average porosity and air leakage rate of the obtained light alloy wheels.

TABLE 3

| | | Cooling means | | | | | | | | |
|---|---|---|---|---|---|---|---|---|---|---|
| | | Wait time | | | Circulation | | | Air pressure | | |
| | Operation sequence | (sec) | | | duration (sec) | | | (×10⁴ Pa) | | |
| | of cooling means | 13a | 13b | 13c | 13a | 13b | 13c | 13a | 13b | 13c |
| Example 10 | 13a→13b→23c | 5 | 20 | 50 | 100 | 100 | 100 | 2 | 2 | 4 |
| Example 11 | 13a→13b→23c | 0 | 10 | 50 | 100 | 100 | 100 | 2 | 2 | 4 |
| Example 12 | 13a→13b→23c | 0 | 10 | 50 | 140 | 120 | 100 | 2 | 2 | 4 |
| Example 13 | 13a→13b→23c | 0 | 10 | 50 | 100 | 100 | 100 | 3 | 2 | 4 |
| Comparative | 13a, 13b, 23c | 5 | 5 | 5 | 100 | 100 | 50 | 2 | 2 | 4 |
| Example 3 | | | | | | | | | | |

| | | | | | | Average | Air |
|---|---|---|---|---|---|---|---|
| | DAS II | | | P_{A} + (P_{B} − P_{A}) × | P_{B} − (P_{B} − P_{A}) × | porosity | leakage |
| | P_{A} | P_{B} | P_{C} | 0.1 | 0.1 | (%) | rate |
| Example 10 | 79 | 87 | 103 | 81.4 | 100.6 | 0.6 | Δ |
| Example 11 | 77 | 87 | 100 | 79.3 | 97.7 | 0.4 | ◯ |
| Example 12 | 74 | 85 | 95 | 76.1 | 92.9 | 0.4 | ◯ |
| Example 13 | 71 | 83 | 98 | 73.7 | 95.3 | 0.3 | ⊚ |
| Comparative | 81 | 82 | 97 | 82.6 | 95.4 | 1.6 | — |
| Example 3 | | | | | | | (reference) |

In the light alloy wheels in Examples 10 to 13, circumferential directional solidification in the rim part 9a was achieved as understood from the DAS II values, and casting defects such as shrinkage cavities occurring in the rim part 9a were less than the light alloy wheel in Comparative Example manufactured by the conventional method. It was found that the air leakage rate of the light alloy wheel was improved in all of Examples 10 to 13 as compared to Comparative Example 3. In Comparative Example 3, circumferential directional solidification of the rim part was imperfect and the light alloy wheel had somewhat more casting defects such as shrinkage cavities in the rim part than the light alloy wheels made by the manufacturing methods used in Examples.

It was found that it is preferable to forcibly cool the molten metal poured into the rim part cavity 100b by performing the forced cooling step so that a relation A<B is satisfied, where A is DAS II in the molten metal solidified in the position P_{A} farthest from the side gate 19 in the rim part cavity 100b and B is DAS II in the molten metal solidified in the position P_{B} in front of the side gate.

Furthermore, it was also found that it is further preferable to forcibly cool the molten metal poured into the rim part-forming cavity by performing the forced cooling step so that A, B and C satisfy the formula (1) below, where C is DAS II in the molten metal solidified in the intermediate position Pc between the position P_{B} of the side gate 19 and the position P_{A} farthest from the side gate 19 in the rim part cavity 100b.

A+(B−A)×0.1<C<B−(B−A)×0.1 (1)

In addition, it was found that the light alloy wheel is preferably configured so that A, B and C satisfy the formula (2) below, where A is DAS II at a position circumferentially farthest from a position with the maximum DAS II on the cross section of the rim part taken orthogonal to the wheel, B is the maximum DAS II and C is DAS II at an intermediate portion between the position with the maximum DAS II and a position circumferentially farthest therefrom.

A+(B−A)×0.1<C<B−(B−A)×0.1 (2)

### INDUSTRIAL APPLICABILITY

The invention is applicable to a light-alloy vehicle wheel which is formed of a light alloy such as aluminum alloy or magnesium alloy and is to be installed on an automobile such as passenger car.

### REFERENCE SIGNS LIST

1: RIM-PART CAVITY
1a: SMALL-VOLUME RIM-PART CAVITY
1b: LARGE-VOLUME RIM-PART CAVITY
2: APERTURE PORTION
3: SPOKE-PORTION CAVITY
4: EXTRA THICKNESS-FORMING SPACE
5: SIDE GATE
9a: RIM PART
9b: RIM MAIN BODY
9b: OUTER FLANGE PORTION (FIRST FLANGE PORTION)
9d: INNER FLANGE PORTION (SECOND FLANGE PORTION)
9e: DISC PART
9f: HUB PORTION
9g: DESIGN PORTION
10: LIGHT ALLOY WHEEL
10a: SOLIDIFICATION START POINT
11: CAVITY
12: LOWER MOLD
13: UPPER MOLD
13a (13a-1, 13a-2): COOLING PIPE (ONE COOLING MEANS)
13b (13b-1 to 13b-4): COOLING PIPE (OTHER COOLING MEANS 1)
13c, 13c′ (13c-1, 13c-2): COOLING PIPE (OTHER COOLING MEANS 2)
13x: INJECTION HOLE
14: MOVABLE SPLIT MOLD
15: CHILLER (COOLING MEANS)
15a: COOLING PIPE
15b: COOLING BLOCK
151: CHILLER (ONE COOLING MEANS)
152, 153: CHILLER (OTHER COOLING MEANS)
18: CENTER GATE
18a: STALK
19: SIDE GATE
21a: HUB PORTION CAVITY
22: SPOKE CAVITY
23a: RIM MAIN BODY CAVITY
23c: COOLING PIPE
25a: INNER FLANGE PORTION CAVITY
26: CROSSING PORTION
27: NON-CROSSING PORTION
80: CASTING SYSTEM
80L: REFERENCE SIGN
80a: AIRTIGHT SEALED CONTAINER
80b: HOLDING FURNACE
80c: LOWER-MOLD PLATEN
80d: MOVABLE PLATEN
80e: GUIDE
80f: UPPER-MOLD PLATEN
80g: GUIDE POST
80h: MOLTEN METAL
80i: POURING GATE
80j: SPRUE BUSH
80k: HYDRAULIC CYLINDER
80m: TOP PLATE
80o: REFERENCE SIGN
80p: REFERENCE SIGN
100 (200): MOLD
100a: DISC PART CAVITY
100b: RIM PART CAVITY
130: AIR SUPPLY MEANS
131 (131a, 131b): FIRST INSIDE SPACE
132 (132a, 132b, 232a to 232d): SECOND INSIDE SPACE
233 (233a to 233d): THIRD INSIDE SPACE

1. A method for manufacturing a light alloy wheel that comprises a substantially annular rim part and a disc part that is joined to one edge of the rim part on an inner side and is to be attached to an axle, the method comprising:
a molten metal pouring step for pouring a light alloy molten metal from a sprue opened into a mold cavity formed into a shape of the rim part; and
a forced cooling step for, after the molten metal pouring step, forcibly cooling the light alloy molten metal poured into the mold cavity formed into the shape of the rim part such that one predetermined cooling means of a plurality of cooling means provided along an entire circumference on an outer side or an inner side of the mold cavity formed into the shape of the rim part is first operated and an other cooling means thereof is then operated.

2. The method for manufacturing a light alloy wheel according to claim 1, wherein the forced cooling step is performed such that one cooling means located farthest from the sprue of the plurality of cooling means is first operated and the other cooling means is then operated in sequence toward the sprue.

3. The method for manufacturing a light alloy wheel according to claim 1, wherein the forced cooling step is performed by forcibly cooling the light alloy molten metal poured into the mold cavity formed into the shape of the rim part such that relative to a cooling power of the one cooling means, a cooling power of the other cooling means decreases toward the sprue.

4. The method for manufacturing a light alloy wheel according to claim 3, wherein an operation time of the cooling means gradually decreases from a position farthest from the sprue toward the sprue.

5. The method for manufacturing a light alloy wheel according to claim 3, wherein the cooling means comprise a coolant path, and a coolant flow rate of the cooling means is gradually reduced from the position farthest from the sprue toward the sprue.

6. The method for manufacturing a light alloy wheel according to claim 1, wherein the light alloy molten metal poured into the mold cavity formed into the shape of the rim part in the molten metal pouring step is directionally solidified from a position farthest from the sprue toward the sprue in the forced cooling step.

7. The method for manufacturing a light alloy wheel according to claim 6, wherein the light alloy molten metal poured into the mold cavity formed into the shape of the rim part is cooled in the forced cooling step such that a relation of A<B is satisfied, where A is a secondary dendrite arm spacing (DAS II) by the secondary arm method of α-Al of the light alloy molten metal solidified at the position farthest from the sprue in the mold cavity formed into the shape of the rim part, and B is a DAS II in the light alloy molten metal solidified in front of the sprue.

8. The method for manufacturing a light alloy wheel according to claim 7, wherein the forced cooling step is performed by forcibly cooling the light alloy molten metal poured into the mold cavity formed into the shape of the rim part such that A, B and C satisfy a formula (1) below, where C is DAS II in the light alloy molten metal solidified at an intermediate portion between the sprue and the position farthest from the sprue in the mold cavity formed into the shape of the rim part.
A+(B−A)×0.1<C<B−(B−A)×0.1 (1)

9. The method for manufacturing a light alloy wheel according to claim 1, wherein the rim part comprises a crossing portion with the disc part, and the plurality of cooling means are disposed along the entire circumference on the outer side or the inner side of the mold cavity formed into a shape of the crossing portion.

10. The method for manufacturing a light alloy wheel according to claim 1, wherein the upper mold comprises a plurality of inside spaces in which the cooling means are enclosed, and at least the one cooling means is enclosed by one of the inside spaces different from the other cooling means.

11. The method for manufacturing a light alloy wheel according to claim 10, wherein the cooling means are each independently enclosed by one of the inside spaces.

12. A light alloy wheel, comprising:
a substantially annular rim part; and
a disc part that is joined to the rim part and is to be attached to an axle,
wherein A, B and C satisfy a formula (2) below, where A is DAS II at a position circumferentially farthest from a position with a maximum DAS II in a cross section of the rim part orthogonal to the axle, B is a maximum DAS II and C is DAS II at an intermediate portion between the position with the maximum DAS II and a position circumferentially farthest therefrom.
A+(B−A)×0.1<C<B−(B−A)×0.1 (2)

13. The light alloy wheel according to claim 12, wherein the rim part comprises a crossing portion with the disc part, and an average porosity of the crossing portion is not more than 1%.

14. A device for manufacturing a light alloy wheel that comprises a substantially annular rim part and a disc part that is joined to one edge of the rim part on an inner side and is to be attached to an axle, the device comprising:
a mold comprising a cavity formed into a shape of the light alloy wheel;
a sprue opened into a cavity formed into a shape of the rim part of the cavity formed into the shape of the light alloy wheel;
a plurality of cooling means attached to the outer side or inner side of the mold cavity formed into the shape of the rim part along a circumferential direction; and
a control means that operates such that, after the light alloy molten metal is poured from the sprue opened into the cavity formed into the shape of the rim part, of the plurality of cooling means, one cooling means located farthest from the sprue is first operated and an other cooling means thereof is then operated in sequence toward the sprue.

15. The device for manufacturing a light alloy wheel according to claim 14, wherein the cooling means comprise a cooling block with a cooling pipe and are attached to the outer side of the cavity formed into the shape of the rim part.

16. The device for manufacturing a light alloy wheel according to claim 14, wherein the upper mold comprises an inside space formed in a circumferential direction along the cavity formed into the shape of the rim part, and the cooling means comprise a cooling pipe arranged in the inside space.

17. The device for manufacturing a light alloy wheel according to claim 16, wherein the one cooling means and the other cooling means are arranged in different ones of the inside space.

18. The device for manufacturing a light alloy wheel according to claim 14, wherein the control means operates such that, after the light alloy molten metal is poured from the sprue opened into the cavity formed into the shape of the rim part, of the plurality of cooling means, one cooling means located farthest from the sprue is first operated and the other cooling means thereof is then operated in sequence toward the sprue, and
wherein the control means controls an operation time or a cooling pressure of the cooling means such that relative to a cooling power of the one cooling means, a cooling power of the other cooling means decreases in sequence toward the sprue.
